(19) United States
(12) Patent Application Publication
(10) Pub. No.: US 2015/0180130 A1
(43) Pub. Date: Jun. 25, 2015

(54) TRIMMING METHOD FOR PATCH ANTENNA AND PATCH ANTENNA STRUCTURE

(71) Applicant: Cirocomm Technology Corp., Tainan City (TW)

(72) Inventor: Tsai-Yi YANG, Tainan City (TW)

(73) Assignee: Cirocomm Technology Corp., Tainan City (TW)

(21) Appl. No.: 14/140,430

(22) Filed: Dec. 24, 2013

(51) Int. Cl. H01Q 9/04; B23K 26/00

(52) U.S. Cl. CPC H01Q 9/0407; B23K 26/0003

(57) ABSTRACT

A testing apparatus drives a laser trimmer to adjust a frequency variation of a patch antenna. A trimming method for the patch antenna includes following steps. The patch antenna is provided. The patch antenna includes an underlying carrier. A radiation metal surface is arranged on a top side of the underlying carrier. The patch antenna is arranged on a testing tool of the testing apparatus. The testing apparatus is configured to turn on and turn off the laser trimmer, so that four or any two of four straight edges of the radiation metal surface are dashed cut to form dashed edges. The testing apparatus tests whether the frequency variation of the patch antenna achieves a target value or not. The testing and adjustment of the frequency variation of the patch antenna are finished if the frequency variation of the patch antenna achieves the target value.

### BACKGROUND OF THE INVENTION

1. Field of the Invention

The present invention relates to an antenna, and especially relates to a trimming method for a patch antenna and a patch antenna structure.

2. Description of the Related Art

A related art ceramic patch antenna includes an underlying carrier. The underlying carrier includes a radiation metal surface on a top side of the underlying carrier. The underlying carrier includes a grounding metal surface on a bottom side of the underlying carrier. A signal feed-in side which is arranged on the underlying carrier is electrically connected to the radiation metal surface through the underlying carrier. The electrical characteristics of the related art ceramic patch antenna should be confirmed to comply with standard specifications through testing after the related art ceramic patch antenna has been manufactured. The printing sizes of the radiation metal sheets of the related art ceramic patch antennas are usually different when the related art ceramic patch antennas are manufactured. Different printing sizes of the radiation metal sheets will result in different electrical characteristics. Therefore, testing the electrical characteristics of the related art ceramic patch antenna is necessary after the related art ceramic patch antenna has been manufactured.

The related art ceramic patch antenna is electrically connected to a connector of a radio frequency (RF) testing coaxial cable when testing the related art ceramic patch antenna. Then, a testing apparatus will test the electrical characteristics of the related art ceramic patch antenna. A Smith chart for the electrical characteristics is shown on the testing apparatus. An auditor will check by eyes to see if the Smith chart shown on the testing apparatus is matched with the standard specifications or not. The auditor has to trim the radiation metal surface of the related art ceramic patch antenna by using a trimming apparatus (holding by hands) if the Smith chart is not matched with the standard specifications. The auditor will stop trimming once the Smith chart shown on the testing apparatus is matched with the standard specifications.

One (or two) of four straight edges of the radiation metal surface is (are) trimmed by a laser trimmer when the related art ceramic patch antenna mentioned above is trimmed. The laser trimmer cannot trim fine due to settings of a laser of the laser trimmer are limited. Therefore, an adjustment of a frequency variation of the related art ceramic patch antenna is limited.

### SUMMARY OF THE INVENTION

Therefore, the main object of the present invention is to solve the problem that the laser trimmer cannot trim fine. The laser trimmer is controlled to turn on and turn off to form dashed edges on the radiation metal surface. In another word, the cut size for a single cut by the laser trimmer is reduced. The method mentioned above is useful for adjusting small frequency variation without affecting the characteristics of the Smith chart of the feed-in impedance too much according to the simulation and experimental results.

In order to achieve the object mentioned above, the present invention provides a trimming method for a patch antenna. A testing apparatus is configured to drive a laser trimmer to adjust a frequency variation of the patch antenna. The trimming method includes following steps. A finished patch antenna is provided. The patch antenna includes an underlying carrier. A radiation metal surface is arranged on a top side of the underlying carrier. The radiation metal surface includes four straight edges. The patch antenna is arranged on a testing tool of the testing apparatus. The testing apparatus is configured to turn on and turn off the laser trimmer, so that four or any two of the four straight edges of the radiation metal surface of the patch antenna are dashed cut to form dashed edges by the laser trimmer. The testing apparatus tests whether the frequency variation of the patch antenna achieves a target value or not. The testing and adjustment of the frequency variation of the patch antenna are finished if the frequency variation of the patch antenna achieves the target value.

Moreover, the underlying carrier of the patch antenna is made of ceramic. A signal feed-in part which is arranged on the underlying carrier and is in columnar shape is electrically connected to the radiation metal surface. The signal feed-in part penetrates a bottom side of the underlying carrier. The signal feed-in part is not electrically connected to a grounding metal surface arranged on the bottom side of the underlying carrier. The radiation metal surface further includes two bevel edges opposite to each other along a diagonal line. The testing apparatus at least includes a micro processing unit, a storage unit, an operation interface and a display. The dashed edge is formed evenly in order to adjust the frequency variation of the patch antenna. The dashed edge includes a plurality of cut segments and a plurality of solid line segments. A cut depth of the cut segment is larger than 0.01 mm. The two dashed edges are connected to each other vertically or are arranged parallel to each other.

In order to achieve the object mentioned above, the present invention provides a patch antenna structure. The patch antenna structure includes an underlying carrier and a radiation metal surface. The underlying carrier includes a top side. The radiation metal surface is arranged on the top side of the underlying carrier. Moreover, the radiation metal surface includes two dashed edges, wherein the two dashed edges are formed to adjust a frequency variation of the patch antenna structure.

Moreover, the underlying carrier of the patch antenna structure is made of ceramic. A signal feed-in part which is arranged on the underlying carrier and is in columnar shape is electrically connected to the radiation metal surface. The signal feed-in part penetrates a bottom side of the underlying carrier. The signal feed-in part is not electrically connected to a grounding metal surface arranged on the bottom side of the underlying carrier. The radiation metal surface further includes two bevel edges opposite to each other along a diagonal line.

The radiation metal surface further includes two straight edges. The straight edge is connected to the bevel edge and the dashed edge. The dashed edge includes a plurality of cut segments and a plurality of solid line segments. The dashed edge is formed evenly on the radiation metal surface. The two dashed edges are connected to each other vertically or are arranged parallel to each other. A cut depth of the cut segment is larger than 0.01 mm.

In order to achieve the object mentioned above, the present invention provides a patch antenna structure. The patch antenna structure includes an underlying carrier and a radiation metal surface. The underlying carrier includes a top side. The radiation metal surface is arranged on the top side of the underlying carrier. Moreover, the radiation metal surface includes four dashed edges, wherein the four dashed edges are formed to adjust a frequency variation of the patch antenna structure.

Moreover, the underlying carrier of the patch antenna structure is made of ceramic. A signal feed-in part which is arranged on the underlying carrier and is in columnar shape is electrically connected to the radiation metal surface. The signal feed-in part penetrates a bottom side of the underlying carrier. The signal feed-in part is not electrically connected to a grounding metal surface arranged on the bottom side of the underlying carrier. The radiation metal surface further includes two bevel edges opposite to each other along a diagonal line. The two bevel edges are connected to the four dashed edges. The dashed edge includes a plurality of cut segments and a plurality of solid line segments. The dashed edge is formed evenly on the radiation metal surface. A cut depth of the cut segment is larger than 0.01 mm.

### BRIEF DESCRIPTION OF DRAWING

FIG. 1 shows a flow chart of a trimming method for a patch antenna of the present invention.

FIG. 2 shows a schematic diagram showing the radiation metal surface of the patch antenna has not been cut.

FIG. 3 shows a schematic diagram showing the radiation metal surface of the patch antenna includes two dashed edges.

FIG. 4 shows a schematic diagram showing the radiation metal surface of the patch antenna includes four dashed edges.

FIG. 5 shows a Smith chart for FIG. 3.

FIG. 6 shows a Smith chart for FIG. 4.

### DETAILED DESCRIPTION OF THE INVENTION

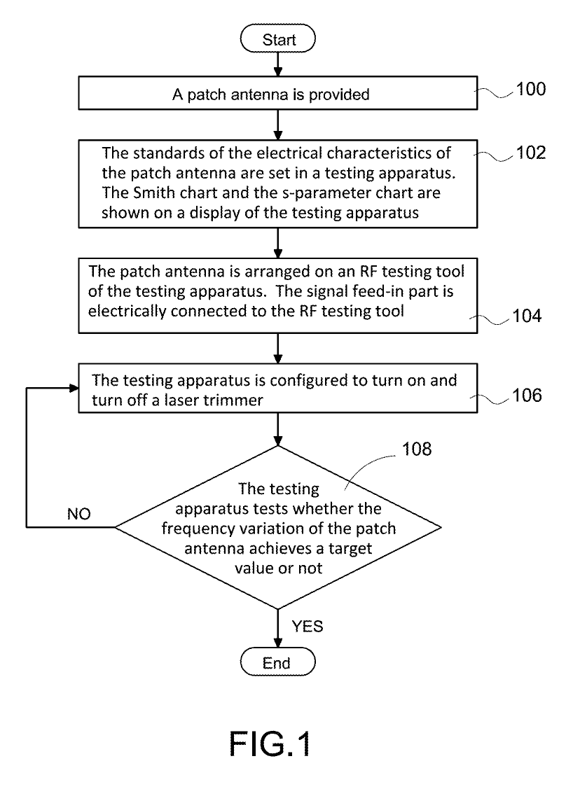

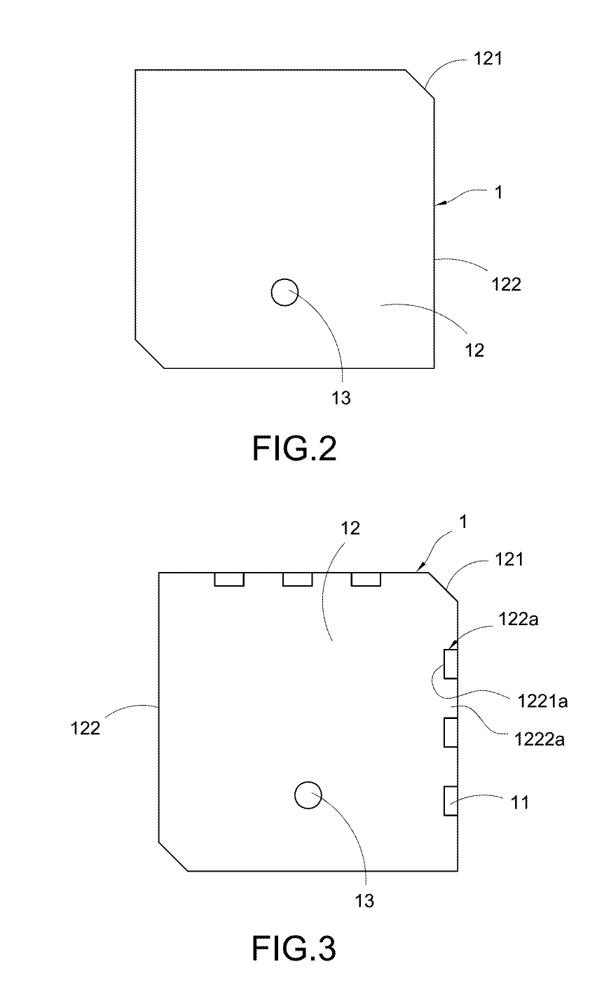

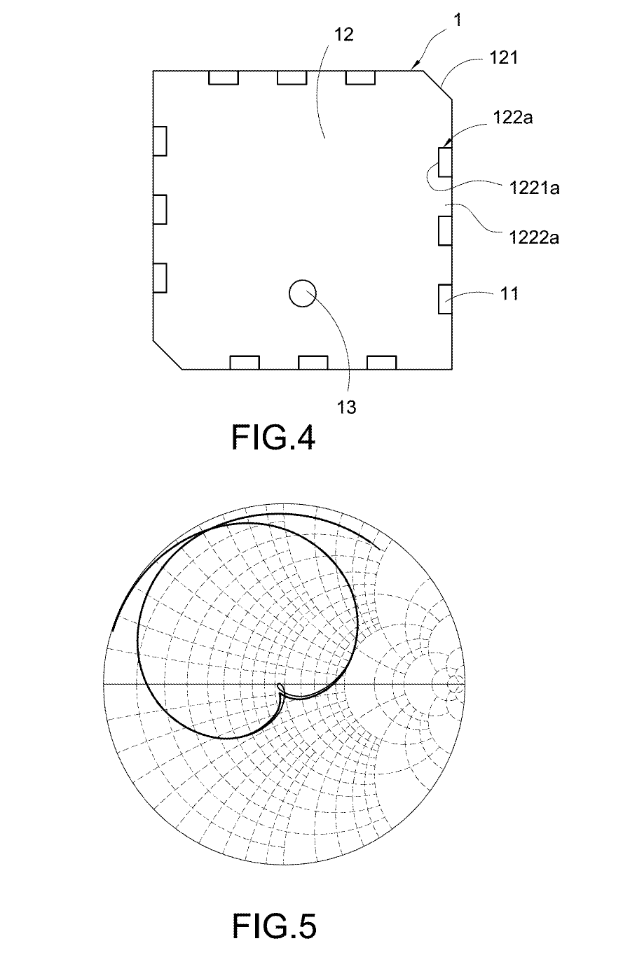

FIG. 1 shows a flow chart of a trimming method for a patch antenna of the present invention. FIG. 2 shows a schematic diagram showing the radiation metal surface of the patch antenna has not been cut. FIG. 3 shows a schematic diagram showing the radiation metal surface of the patch antenna includes two dashed edges. FIG. 4 shows a schematic diagram showing the radiation metal surface of the patch antenna includes four dashed edges. The trimming method for a patch antenna of the present invention includes following steps. A patch antenna 1 is provided (step 100). The patch antenna 1 includes an underlying carrier 11. A radiation metal surface 12 is arranged on a top side of the underlying carrier 11. The radiation metal surface 12 includes two bevel edges 121 opposite to each other along a diagonal line and four straight edges 122. Moreover, a signal feed-in part 13 which is arranged on the underlying carrier 11 and is in columnar shape is electrically connected to the radiation metal surface 12. The signal feed-in part 13 penetrates the underlying carrier 11. The signal feed-in part 13 penetrates a bottom side (not shown in FIGS. 1-4) of the underlying carrier 11. The signal feed-in part 13 is not electrically connected to a grounding metal surface (not shown in FIGS. 1-4) arranged on the bottom side of the underlying carrier 11. The underlying carrier 11 is made of ceramic.

The standards of the electrical characteristics (for examples, the center frequency, the bandwidth and the return loss) of the patch antenna 1 are set in a testing apparatus (not shown in FIGS. 1-4). The Smith chart and the s-parameter chart are shown on a display of the testing apparatus (step 102). The testing apparatus at least includes a micro processing unit, a storage unit, an operation interface and the display. The micro processing unit is electrically connected to the storage unit, the operation interface and the display.

The patch antenna 1 is arranged on an RF (radio frequency) testing tool of the testing apparatus. The signal feed-in part 13 is electrically connected to the RF testing tool (step 104). The RF testing tool is an RF coaxial cable connector electrically connected to the signal feed-in part 13.

When the frequency variation of the patch antenna 1 needs adjustment, the testing apparatus is configured to turn on and turn off a laser trimmer (not shown in FIGS. 1-4) (step 106), so that four or any two of the four straight edges 122 of the radiation metal surface 12 of the patch antenna 1 are dashed cut to form dashed edges 122a by the laser trimmer. The dashed edge 122 is formed evenly (as shown in FIG. 3 and FIG. 4) in order to adjust the frequency variation of the patch antenna 1.

The testing apparatus tests whether the frequency variation of the patch antenna 1 achieves a target value or not (step 108). If not, the process goes back to step 106. If yes, the process is finished.

FIG. 5 shows a Smith chart for FIG. 3. Please refer to FIG. 3 as well. After the patch antenna 1 is trimmed by the laser trimmer, the patch antenna 1 includes the underlying carrier 11. The radiation metal surface 12 is arranged on the top side of the underlying carrier 11. The radiation metal surface 12 includes two bevel edges 121 opposite to each other along a diagonal line. The two bevel edges 121 are connected to two straight edges 122 and two dashed edges 122a. The two dashed edges 122a are connected to each other vertically or are arranged parallel to each other (connected to the two straight edges 122). The dashed edge 122a includes a plurality of cut segments 1221a and a plurality of solid line segments 1222a. A part of the radiation metal surface 12 atop the underlying carrier 11 is removed to expose the underlying carrier 11 (cut by the laser trimmer) to form the cut segments 1221a. Therefore, as can be seen from FIG. 3, the dashed edge 122a comprises alternately arranged cut segments 1221a and solid line segments 1222a, so it looks like a dashed line from top view. It should be noted that the cut segments 1221a are formed by cutting a portion of the radiation metal surface 12 to certain extent, for example, to expose the underlying carrier 11.

Moreover, the frequency variation of the patch antenna 1 is affected by a cut depth (or width) of the cut segment 1221a, as shown in the following table.

| | frequency | frequency variation |
|---|---|---|
| item | (GH_{Z}) | (MH_{Z}) |
| original | 1.5631 | 0 |
| 0.02 mm | 1.5645 | 1.4 |
| 0.025 mm | 1.5647 | 0.2 |
| 0.03 mm | 1.5656 | 0.9 |
| 0.035 mm | 1.5659 | 0.3 |
| 0.04 mm | 1.5665 | 0.6 |
| 0.045 mm | 1.567 | 0.5 |
| 0.05 mm | 1.5673 | 0.3 |

If the cut depth increases 0.005 mm, the frequency variation increases 0.42 MHz averagely.

Therefore, according to the table mentioned above, the cut depth of the cut segment 1221a is larger than 0.01 mm.

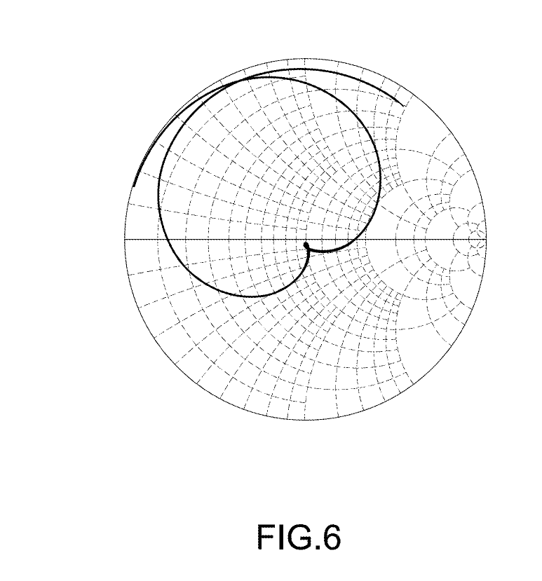

FIG. 6 shows a Smith chart for FIG. 4. Please refer to FIG. 4 as well. After the patch antenna 1 is trimmed by the laser trimmer, the patch antenna 1 includes the underlying carrier 11. The radiation metal surface 12 is arranged on the top side of the underlying carrier 11. The radiation metal surface 12 includes two bevel edges 121 opposite to each other along a diagonal line. The two bevel edges 121 are connected to four dashed edges 122a. The dashed edge 122a includes a plurality of cut segments 1221a and a plurality of solid line segments 1222a.

Moreover, the frequency variation of the patch antenna 1 is affected by a cut depth (or width) of the cut segment 1221a, as shown in the following table.

| | frequency | Frequency variation |
|---|---|---|
| item | (GH_{Z}) | (MH_{Z}) |
| original | 1.5603 | 0 |
| 0.02 mm | 1.5649 | 4.6 |
| 0.025 mm | 1.5655 | 0.6 |
| 0.03 mm | 1.5663 | 0.8 |
| 0.035 mm | 1.5674 | 1.1 |
| 0.04 mm | 1.5679 | 0.5 |
| 0.045 mm | 1.5688 | 0.9 |
| 0.05 mm | 1.5692 | 0.4 |

If the cut depth increases 0.005 mm, the frequency variation increases 0.82 MHz averagely.

Therefore, according to the table mentioned above, the cut depth of the cut segment 1221a is larger than 0.01 mm.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A trimming method for a patch antenna, the method using a testing apparatus to drive a laser trimmer to adjust a frequency variation of the patch antenna, the trimming method comprising:
(a) providing a finished patch antenna, wherein the patch antenna comprises an underlying carrier; a radiation metal surface arranged on a top side of the underlying carrier; the radiation metal surface comprises four straight edges;
(b) arranging the patch antenna on a testing tool of the testing apparatus;
(c) turning on and turning off the laser trimmer by the testing apparatus, so that four or any two of the four straight edges of the radiation metal surface of the patch antenna are dashed cut to form dashed edges by the laser trimmer;
(d) using the testing apparatus to check whether the frequency variation of the patch antenna achieves a target value or not; and
(e) finishing the trimming process if the frequency variation of the patch antenna achieves the target value.

2. The trimming method in claim 1, wherein the underlying carrier of the patch antenna is made of ceramic; a signal feed-in part arranged on the underlying carrier and of columnar shape is electrically connected to the radiation metal surface; the signal feed-in part penetrates a bottom side of the underlying carrier; the signal feed-in part is not electrically connected to a grounding metal surface arranged on the bottom side of the underlying carrier.

3. The trimming method in claim 2, wherein the radiation metal surface further comprises two bevel edges opposite to each other along a diagonal line.

4. The trimming method in claim 3, wherein the testing apparatus at least comprises a micro processing unit, a storage unit, an operation interface and a display; the micro processing unit is electrically connected to the storage unit, the operation interface and the display.

5. The trimming method in claim 4, wherein the dashed edge is formed evenly in order to adjust the frequency variation of the patch antenna.

6. The trimming method in claim 5, wherein the dashed edge comprises a plurality of cut segments and a plurality of solid line segments.

7. The trimming method in claim 6, wherein a cut depth of the cut segment is larger than 0.01 mm.

8. The trimming method in claim 7, wherein the two dashed edges are connected to each other vertically or are arranged parallel to each other.

9. A patch antenna structure comprising:
an underlying carrier comprising a top side; and
a radiation metal surface arranged on the top side of the underlying carrier,
wherein the radiation metal surface comprises two dashed edges; the two dashed edges are formed to adjust a frequency variation of the patch antenna structure.

10. The patch antenna structure in claim 9, wherein the underlying carrier of the patch antenna structure is made of ceramic; a signal feed-in part arranged on the underlying carrier and of columnar shape is electrically connected to the radiation metal surface; the signal feed-in part penetrates a bottom side of the underlying carrier; the signal feed-in part is not electrically connected to a grounding metal surface arranged on the bottom side of the underlying carrier.

11. The patch antenna structure in claim 10, wherein the radiation metal surface further comprises two bevel edges opposite to each other along a diagonal line.

12. The patch antenna structure in claim 11, wherein the radiation metal surface further comprises two straight edges; the straight edge is connected to the bevel edge and the dashed edge.

13. The patch antenna structure in claim 12, wherein the dashed edge comprises a plurality of cut segments and a plurality of solid line segments.

14. The patch antenna structure in claim 13, wherein the dashed edge is formed evenly on the radiation metal surface.

15. The patch antenna structure in claim 14, wherein the two dashed edges are connected to each other vertically or are arranged parallel to each other.

16. The patch antenna structure in claim 15, wherein a cut depth of the cut segment is larger than 0.01 mm.

17. A patch antenna structure comprising:
an underlying carrier comprising a top side; and
a radiation metal surface arranged on the top side of the underlying carrier,
wherein the radiation metal surface comprises four dashed edges; the four dashed edges are formed to adjust a frequency variation of the patch antenna structure.

18. The patch antenna structure in claim 17, wherein the underlying carrier of the patch antenna structure is made of ceramic; a signal feed-in part arranged on the underlying carrier and of columnar shape is electrically connected to the radiation metal surface; the signal feed-in part penetrates a bottom side of the underlying carrier; the signal feed-in part is not electrically connected to a grounding metal surface arranged on the bottom side of the underlying carrier.

19. The patch antenna structure in claim 18, wherein the radiation metal surface further comprises two bevel edges opposite to each other along a diagonal line.

20. The patch antenna structure in claim 19, wherein the two bevel edges are connected to the four dashed edges.

21. The patch antenna structure in claim 20, wherein the dashed edge comprises a plurality of cut segments and a plurality of solid line segments.

22. The patch antenna structure in claim 21, wherein the dashed edge is formed evenly on the radiation metal surface.

23. The patch antenna structure in claim 22, wherein a cut depth of the cut segment is larger than 0.01 mm.
